(19) United States
(12) Patent Application Publication
(10) Pub. No.: US 2005/0007988 A1
(43) Pub. Date: Jan. 13, 2005

(54) Digital interface between analogue rf hardware and digital processing hardware

(76) Inventors: Gavin Robert Ferris, London (GB); Christopher Alfred Udy, SW185LL (GB)

Correspondence Address: Richard C Woodbridge;Synnestvedt Lechner & Woodbridge, P O Box 592, Princeton, NJ, 08542-0592, US

(21) Appl. No.: 10/468,327

(22) PCT Filed: Feb. 14, 2002
(86) PCT No.: PCT/GB02/00639

(30) Foreign Application Priority Data
Feb. 16, 2001 (GB) 010139031

(51) Int. Cl. H04J 3/16

(52) U.S. Cl. 370/349; 370/469

(57) ABSTRACT

A digital interface between analogue RF hardware and digital processing hardware which (a) defines how the analogue RF hardware and digital processing hardware send and receive digital data to one another and (b) is open in order to decouple the design of the analogue RF hardware from the design of the digital processing hardware. The adoption of such an interface will facilitate the uptake of software defined radio (SDR), both as a design-time and run-time technology, as it enables the production of analogue/RF components independently from the digital domain hardware and software.

### BACKGROUND TO THE INVENTION

1. Field of the Invention

This invention relates to a digital interface between analogue RF hardware and digital processing hardware. It is relevant to Software Defined Radio (SDR) and finds particular application in, for example, SDR basestations.

2. Description of the Prior Art

A basestation is a transceiver node in a radio communications system, such as UMTS (Universal Mobile Telephony System). Conventionally, one basestation communicates with multiple user equipment terminals. Digital radio basestations (Node Bs) include analogue RF (Radio Frequency) hardware components; these components receive RF signals from an antenna and down convert them to lower frequency signals (e.g. a real frequency at low IF (intermediate frequency) or quadrature components (IQ) at zero IF). These IF signals are then digitised by an ADC (Analogue to Digital Convertor) into the digital domain and then passed to digital processing hardware to extract useful information. The inverse process occurs for transmission—a DAC accepts digital data from digital processing hardware, synthesises an analogue signal and passes these signals up via an upconverter to a RF antenna.

The skills needed for analogue RF hardware design are however very different from those needed for designing digital processing hardware. In practice, this has meant that only relatively large organisations have been able to design and build basestations, since only they are able to support the large, integrated design teams with skill sets that extend across both analogue RF and digital processing hardware design. This in turn has led to the analogue RF side and the digital processing hardware side being very closely integrated together (as opposed to being cleanly separable, modular designs, for example). The interfaces between them are closed and proprietary as opposed to open (an open interface is one which is published so that anyone can read it). The consequence of the closed and proprietary interfaces is that conventional basestations are inflexible and costly.

The monolithic approach exemplified in a conventional basestation can be contrasted with the approach of Software Defined Radio (SDR); SDR is a term used to refer to a collection of generally reconfigurable hardware and software components that enable the production of flexible, future-proofed products for wireless network infrastructure and end user terminals. SDR has the potential to allow multi-mode, multi-band, multi-functional wireless devices that can be enhanced using software upgrades. With the use of software comes the advantage of modularity and re-use, which may be extended to the integration of multiple vendor Intellectual Property (IP) on a single product. It also allows the use of a single hardware platform to cover many distinct standards.

However, at the moment, realistic SDR systems cannot be implemented entirely in software, for most wireless standards. This is because, first, it is not yet possible to convert data between the analogue and digital domains rapidly enough to analyse or synthesize signals directly at their target radio frequency (RF). As a consequence, current broadcast and communications equipment must (as noted above) make use of analogue circuitry to convert data to (from) either a real signal at a low intermediate frequency (IF), or else quadrature components at a zero Hz IF (IQ), at which point it may be digitised (synthesised) with the use of an ADC (DAC).

Secondly, although it would appear that once within the digital domain, flexible processing elements may be used to transform the signals using fully configurable software techniques, this is not in fact quite true (‘software’ in this context, covers also configurations loaded into FPGA devices). With the increase in required data payloads for communications and broadcast systems, very sophisticated modulation and channel processing algorithms are rapidly being brought into play (for example, the move towards Turbo codes to replace standard convolutional codes; sophisticated multi-user detection (MUD), and antenna array processing, to name but a few), with the result that instruction loading on such systems is increasing with time faster than Moore's law. Consequently, significant parallelism must be utilised in system designs and, because of the lack of appropriate generic parallel processors, this is most commonly achieved through the use of hardware, which is either reprogrammable (e.g., a Xilinx FPGA), in which case it is expensive, militating against its widespread use, or not, in which case the resultant system does not really embody the true goals of SDR as the final system will not be entirely reprogrammable.

So at present, SDR systems tend to be somewhat hybrid designs, consisting of (a) analogue RF units (b) generalised and specialised digital execution hardware, and (c) software elements running on that hardware.

### SUMMARY OF THE INVENTION

In a first aspect of the invention, there is a digital interface between analogue RF hardware and digital processing hardware which (a) defines how the analogue RF hardware and digital processing hardware send and receive digital data to one another and (b) is open in order to decouple the design of the analogue RF hardware from the design of the digital processing hardware.

A SDR may run on the digital processing hardware; the adoption of the above interface will facilitate the uptake of SDR, both as a design-time and run-time technology, as it enables the production of analogue RF components independently from the digital domain hardware and SDR software. Hence, experts in analogue RF hardware design can now design for this interface; separately, experts in digital processing hardware can also design for this interface.

But critically, these separate groupings no longer need to be tightly integrated with each other within a single organisation. This is a critical point: SDR is a rapidly growing technology that is set to have far reaching impacts upon both infrastructure and terminal design in the digital broadcast and communication markets. However, if there is one defining feature of these systems, it is their overwhelming complexity. The present invention is predicated on the insight that the key to defeating complexity is to partition a problem at its points of articulation—in the present case to decouple the design of analogue RF hardware from the design of digital processing hardware by defining an open interface between them. This approach enables analogue RF component solutions to be built by analogue RF specialist companies and digital processing hardware to be built by different specialist companies, which may then rapidly be aggregated together to form higher-level solutions.

The term ‘RF hardware’ may refer to the analogue components device which simply transforms data to and from the digital domain at IF or 0 Hz IQ. Analogue RF hardware typically presents a DAC and ADC to the open digital interface.

The digital interface enables high speed control and user data (i.e. content related data, such as speech etc.) to be sent between front-end, analogue RF processing units, and back-end, generic digital signal processing components, for use within basestation, test and prototyping products.

The interface may be extensible so that the overall system architecture need not be changed when processing different communications or broadcast standards.

An implementation of the present invention utilises the User Datagram Protocol over IP (UDP/IP) to carry information. The configuration of RF hardware is realised using the Simple Network Management Protocol (SNMP), as many different technical specifications can be represented as a standard set of messages (e.g. Power Amplifier (PA) ramping, frequency tuning, etc.) coupled with a small set of application specific messages built from the standard set. Both UDP/IP and SNMP are open standards, again in contrast to the proprietary and closed protocols used in the prior art, monolithic designs.

Overall, by defining an open digital interface between analogue RF hardware and digital processing hardware, the following benefits are realised:
i) An open interface allows the integration of 3^{rd} party analogue RF hardware and digital processing hardware in a single product and also the development of stand-alone test equipment for black-box software stack testing.
ii) The configuration of analogue RF hardware is presented as a standard set of messages which can be reused when developing wireless products for alternative standards.
iii) A manufacturer can focus resources on the development of the software stack to run on the digital processing hardware and migrate the solution towards an ASIC without complete knowledge of the analogue RF circuitry to be deployed. This is of particular benefit for User Equipment (UE) development.

Further details of the invention are defined in the Claims. Other aspects of the invention include:
Analogue RF hardware adapted to send digital data to, and to receive digital data from, digital processing hardware, in which the digital data conforms to the open digital interface defined in the first aspect.
Digital processing hardware adapted to send digital data to, and to receive digital data from, analogue RF hardware, in which the digital data conforms to the open digital interface defined in the first aspect.
Digital data which conforms to the open digital interface defined in the first aspect.

### BRIEF DESCRIPTION OF THE DRAWINGS

The invention will be described with reference to the accompanying drawings in which

FIG. 1 is a schematic showing how a genetic baseband processor (GBP) platform utilises the present invention, in an implementation called OpenIF™, to connect to an analogue RF head;

FIG. 2 shows an example electrical interface;

FIG. 3 shows an OpenIF interface protocol stack;

FIG. 4 shows data packet frame construction in OpenIF;

FIG. 5 shows a User Data Header in OpenIF;

FIG. 6 shows CP Frame Construction in OpenIF;

### DETAILED DESCRIPTION

Communications and broadcast infrastructure design (and terminal prototyping systems design) is readily decomposed between the RF units, the digital processing hardware, and the software that executes upon that hardware. In this specification, a high level overview of a candidate for an open interface between the first of these two subsystems is described. This interface, termed OpenIF™, has been developed at RadioScape Limited, London, United Kingdom.

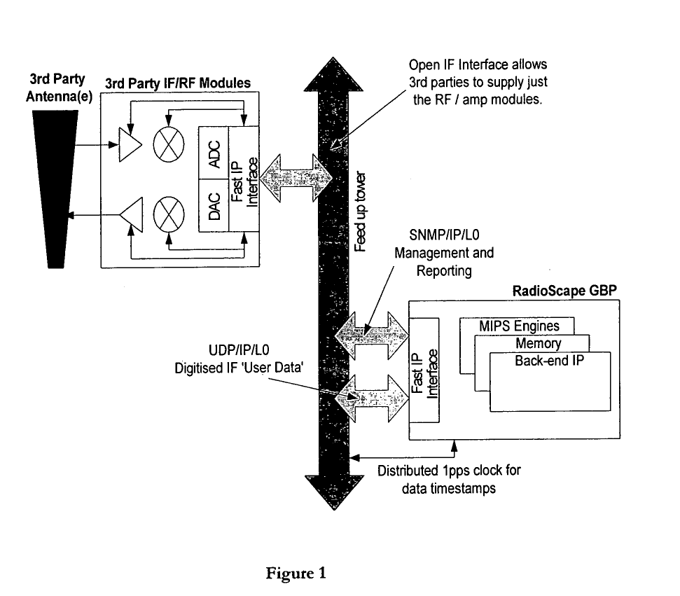

Consider FIG. 1, which shows the RadioScape generic baseband processor (GBP) platform, and how it utilises OpenIF™ to connect to an RF head. The GBP platform is a FPGA/DSP substrate for high-bandwidth digital processing. It is designed to be a general-purpose high-performance DSP platform for the development and prototyping of modern communications applications. Because the requirements of specific applications will be different, the architecture is designed to be scalable through the use of a ‘plug-in’ modular architecture. One (or more) of the plug-in modules will be the analogue front end RF unit. An individual RF unit may be a receiver, a transmitter or both, and may generate/accept data at 0 Hz IQ or a (relatively) low IF in the real-only domain. The range of frequencies supported by an individual RF board will be limited, but the OpenIF™ interface with the GBP is sufficiently generic to support applications in any frequency space. In the mobile communications domain it is assumed that the IF/RF hardware will be generating and receiving radio waves, but this does not prevent the possibility utilising other transmission media, such as optical fibre.

Usage Scenarios

For the purposes of introducing the OpenIF™ interface, the development of a 3GPP W-CDMA UMTS basestation with an underlying LVDS bus technology has been considered. However, bear in mind that there is nothing in the OpenIF™ definition that restricts it either to W-CDMA, infrastructure or bus LVDS as an underlying digital interconnect. For example, one could use OpenIF™ to connect the RF head for an IS-95 terminal emulation, with the digital interconnect hosted over Fibre Channel. Furthermore, although we will use the RadioScape GBP as the ‘back end’ digital signal processing engine, any other third party hardware could be used instead; this interoperability of RF and digital components being the entire point of the OpenIF™ protocol.)

On the transmit side, the GBP application will be generating an IF stream at a constant rate. In UMTS this rate will be 3.84 million chips per second (Mcps). In this example, software on the application side of the interface will be converting this into a digital representation of the required waveform with 8 times over-sampling and 16 bits per sample (so we will be sending the hardware 3.84×8×16 million bits per second; 492 Mbps, 62 Megabytes/second). However, the underlying LVDS bus technology will clock 16-bits at 40 MHz providing a total bandwidth of 640 Mbps, catering for both data and signalling overhead to carry control messages as described in this specification. The data stream is broken down into frames and slots; in UMTS this will be 100 frames/second and 15 slots per frame. This concept, with different values, can be carried into most communications protocols.) On the receive side, the RF unit will be collecting data from the analogue downconverter circuitry and digitising it for delivery back to the GBP. For a single antenna in a Node B (basestation) the data rates will be similar to the outbound stream, but for other protocols, for instance ADSL, this won't be the case. Even with an application like a W-CDMA basestation we may choose different bits per sample in the up and downlinks.) In both cases, we assume that the final ‘IF’ is at 0 Hz and that we have an IQ stream present, rather than a low-frequency real-only IF signal, which would be an alternative for this application.

Receive and Transmit Diversity introduces the concept of multiple antennas and multiplies the calculated bandwidths by ‘n’, the number of antennas in an array. OpenIF™ supports the concept of multiple arrays using multiple IP addressing. Each front end module is configured with it's own IP address, allowing the GBP to address groups of front end modules (i.e. multicasting) or single modules at a time. In the reverse direction the GBP maintains a single IP address where all front end receiver modules can direct received data.

Digital Front End Interface

An Example Electrical Interface

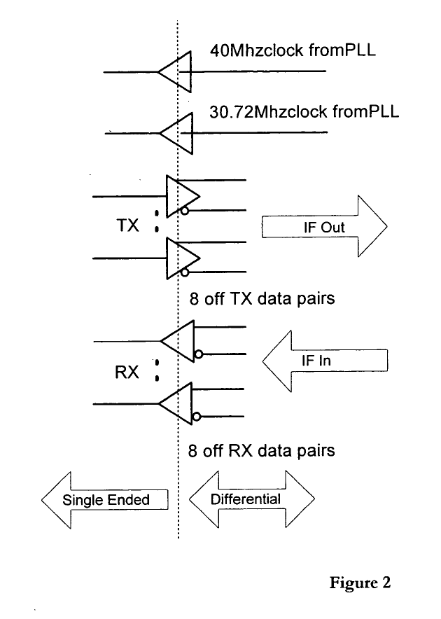

An example electrical interface, shown at FIG. 2, is discussed briefly below. Again it is important to remember that the choice of LVDS represents only one possible option, shown here for the sake of being concrete.

The hardware interface is designed to fit into a PMC form factor. The connector is a 50-way high-density D socket. The electrical interface uses LVDS and the connector supports up to 25 differential pairs. There are separate transmit and receive channels, each of which supports 16-bit data on an 8-bit wide interface by clocking on alternate edges of the clock. A similar transfer scheme is used on the latest version of LVD SCSI, which can transfer words on each edge of a 40 MHz clock over 12 metres. The channels on the open interface can easily support a data rate of up to 8 times the chip rate (30.72 Msamples/sec) over a similar distance.

Control, status and time stamp information are sent on the data channels, interleaved with the data as separate UDP/IP packets. The data transfer clock is increased to 40 MHz to provide sufficient bandwidth for the data (at 30.72 Mhz) and control/status. The time stamp (generated from a GPS 1 pps signal) for the packet is kept and put back from transmit to receive.

The Protocol Stack

The OpenIF™ interface carries three different kinds of information flow between the GBP and the RF front end.
The D-Plane (data-plane) carries ‘user data’ (i.e. content related data)—ADC or DAC information, either in real-only or IQ format, to and from the RF front end
The C-Plane (control-plane) carries control data to the front end (and appropriate responses and signalling back from it).
The M-Plane (management-plane) carries management data to the RF front end (and appropriate responses and signalling back from it). M-Plane messages are much less dynamic in their application than those in the C-Plane.

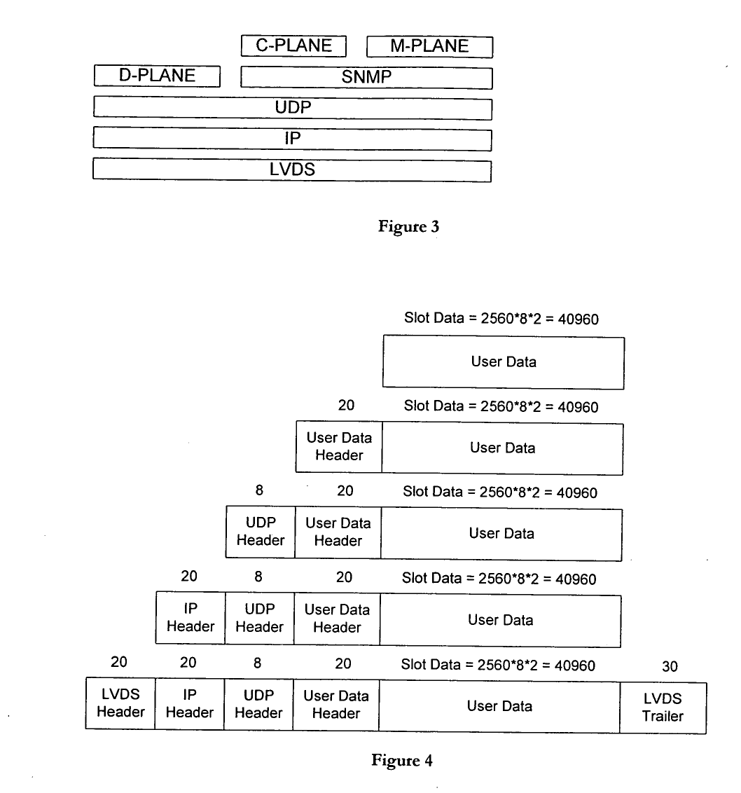

FIG. 3 shows an OpenIF interface protocol stack. As can be seen, all three types of data run off a single electrical interface using both IP and UDP. The control and management information uses SNMP to query and configure the hardware status. Note: while bus-LVDS has been described here (and is a synchronous protocol), other variants may be used, such as Ethernet, Fibre Channel, USB, etc. OpenIF™ is timestamped and so supports use over either synchronous or asynchronous underlying transports.

Protocol Requirements

The GBP communicates with the RF hardware (or vice versa) using either a Data Packet (DP), a Control Packet (CP), or a Management Packet (MP). Each type of packet shall be transmitted using the appropriate plane (see above).

The following frame construction is used when creating a DP for transmission to or from the RF hardware (all size header/payload sizes are in bytes). Note: for our particular example, the numbers in the User Data section represent a single slot of IF data (16-bit, eight times oversampling in UMTS (2560 chips) and are for illustration purposes only. The actual user data length is included in the “User Data Header”.

FIG. 4 shows DP Frame Construction. The content of the User Data Header shall consists of the following byte packed fields. Note: the LSB is considered to be at the right of the diagram.

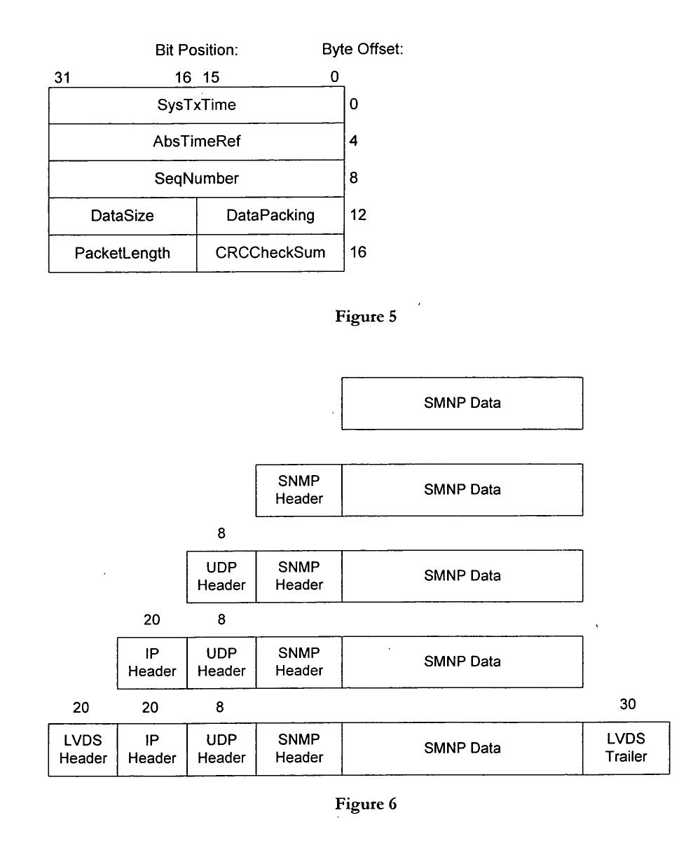

FIG. 5 shows the User Data Header. The individual fields in the User Data Header are defined as:
SysTxTime, the system transmit time, is an application specific time construct indicating the transmit time for the current packet. Several default classes of time are defined for general use. These may be tied to the 1 pps system reference if distribution across an asynchronous bearer is required.
AbsTimeRef is an absolute time reference for the packet generated from the Generic Baseband Processor (GBP) and based on the distributed 1 pps pulse.
DataSize indicates the size of the individual data elements (8-bit, 16-bit, 32-bit, etc.)
DataPacking indicates whether the data is packed as IF data (sequential samples) or an I/Q stream (alternating I/Q samples).
Packet Length indicates the number of bytes of data in the User Data of a DP message.
The CRC checksum of the User Data Header shall be generated using the following polynomial: (intial seed=0)
   G(D)=D¹⁶+D¹²+D⁵+1

The diagram above represents a possible configuration for UMTS, other configurations for this example LVDS system might be:

| DATA | | | USER PACKET |
|---|---|---|---|
| PACKING | DATA SIZE | OVERSAMPLING | SIZE (BYTES) |
| IF Data | 32-bit samples | 4 | 40960 |
| IF Data | 8-bit samples | 4 | 20480 |
| I/Q Data | 16-bit samples | 4 | 40960 |
| I/Q Data | 8-bit samples | 4 | 20480 |

Note: the only limitation on configurations is the physical layer bandwidth, which in this example is limited by the 40 MHz LVDS clock.

Data is assumed to be represented as signed 2s complement numbers, big-endian.

The structure of the IP header is defined by IPv4 and any applicable fields from the RFC 791 [Postel 1981a] official specification of IP, in addition the structure of the UDP header is defined in RFC 768 [Postel 1980]. It is important to remember that each analogue front module attached to the GBP has it's own IP address, thus both multi-casting (for simple transmit diversity) and single configurations are possible.

The content of the physical layer header and trailer consists of a preamble and frame delimiter portions, and optionally channel coding information, all of which are taken from the relevant specification (e.g. IEEE 802.3 for an Ethernet connection, etc.). The content of the physical layer header must provide a synchronisation mechanism (nb—this is only to allow the packet to be acquired; time synchronisation of the payload is accomplished through the use of the 1 pps timestamp and associated offset) if an asynchronous physical layer is used. In this example, the LVDS header and trailer are proprietary structures consisting of a frame delimiter portion and a CRC checksum (Trailer only) of the User Data. The CRC checksum is generated with the following polynomial: (initial seed=0)
G(D)=D¹⁶+D¹²+D⁵+1

FIG. 6 shows CP Frame Construction to be used when creating a CP or MP for transmission to or from the hardware: All size header/payload sizes are in bytes. The structure of the SNMP header and data is defined in RFC 1157 [Case et al. 1990], which defines the format of the SNMP packets exchanged. Both are variable length structures.

Again, the content of the physical layer header and trailer shall ideally consist of a preamble and frame delimiter portions, and optionally channel coding information, all of which is taken from the relevant specification.

RF Hardware Message Set

The message set can be divided into the following domains:
1. Data, receive and transmit
2. Messages from the GBP to the front end hardware.
3. Information from the front end hardware to the GBP in response to queries.
4. Traps generated by the front end hardware in response to events therein.

Types 2-4 can be further sub-divided into generic and application/vendor specific messages. Type (1) messages are transmitted in Data Packets and the remaining messages in Control Packets or Management Packets.

SNMP Specifics

The data part of the communications are carried in the RadioScape proprietary message structure over UDP, as described previously. All the control and management messages, plus replies and traps will be carried using SNMP.

Through the adoption of SNMP, a generic monitoring system has effectively been introduced as a functional layer above the IP/UDP subsystem. Clearly, some SNMP specifics are required in order to allow the development of 3^{rd} Party RF hardware that will function correctly with the ‘back end’ hardware (in this case, with a RadioScape GBP).

The fundamental object of SNMP is the Management Information Base (MIB). A MIB is conceptually a tree view of variables exposed to SNMP for getting and setting. The variables in this case are embedded within a specific RadioScape application. The MIB contains all information necessary to find, validate, get and set these variables.

This system requires two different representations of the same MIB. One MIB representation is the SNMP-standard text file in ASN.1 notation. This file can be imported into SNMP Management Software to give the manager access to RadioScape's exposed variables. The second representation is within the MIB database—an implementation-oriented viewpoint of the MIB.

MIB Configuration

RadioScape maintains a MIB subtree, branching from the ‘enterprises’ node in MIB-II according to RFC 1213 [McCloghrie and Rose 1991]. Every MIB for RadioScape GBP applications begins at:
.iso.org.dod.internet.private.enterprises.
   radioscape.products.rsGBP

Further to this, the next entry is an identifier (with an associated MIB) for the open IF interface.
.iso.org.dod.internet.private.enterprises.
   radioscape.products.rsGBP.IFInterface

Further to this, the next entry is an identifier (with an associated MID) for any extra messages required for a specific product or application, for instance a UMTS basestation.
iso.org.dod.internet.private.enterprises.
   radioscape.products.rsGBP.IFInterface.UMTS
      SNMP Controlled Variables

The following tables indicate the values that are communicated between the IF hardware and the GBP using the SNMP packets in the physical stream. The variable names used correspond to entries in the MIB defined above. The values in the attributes column consist of an ordered triplet, (Indexed, Access, Type).

Indexed can be Y (yes) or N (no), Access can be RO (read only), WO (write only), RW (read and write) and Type can be I (an integer) or S (a string). Note that a particular value may be indicated as writable but a particular implementation might not support this. Similarly some devices might not be able to support the full range of some parameters.

All messages may be timestamped either to a slot/frame boundary or a absolute (i.e. wrt the 1 pps distributed clock) if required.

Generic Messages

Please note that these have not been partitioned here between C and M-planes for simplicity.

General Configuration: provides the ability to get and set core parameters for the expected user data format. Most signals can be divided into a three level hierarchy, samples, slots and frames. This matches nicely into W-CDMA, and most communications strategies have equivalent concepts. The interface supports the following values. Note the number of bits used by the ADC/DAC might be fewer than those actually in transmitted per sample.

| VARIABLE NAME | ATTRIBUTES | RANGE |
|---|---|---|
| Rx_samples_per_slot | N, RW, I | 1-(2³¹ − 1) |
| Rx_slots_per_frame | N, RW, I | 1-(2³¹ − 1) |
| Rx_bits_per_sample | N, RW, I | 1-31 |
| Rx_adc_bits | N, RW, I | 1-31 |
| Tx_samples_per_slot | N, RW, I | 1-(2³¹ − 1) |
| Tx_slots_per_frame | N, RW, I | 1-(2³¹ − 1) |
| Tx_bits_per_sample | N, RW, I | 1-31 |
| Tx_dac_bits | N, RW, I | 1-31 |

RF Center Frequency: Will provide the ability to get and set the centre frequency of the RF signals being transmitted/received. The frequency will be set as two integers, a number in the range 1-(2³¹−1) and an exponent in the range 1-31. This will support frequencies in the range 1 to 2×10⁴⁰ Hz.

| VARIABLE NAME | ATTRIBUTES | RANGE |
|---|---|---|
| Rx_centre_frequency_exponent | N, RW, I | 1-31 |
| Rx_centre_frequency_value | N, RW, I | 1-(2³¹ − 1) |
| Tx_centre_frequency_exponent | N, RW, I | 1-31 |
| Tx_centre_frequency_value | N, RW, I | 1-(2³¹ − 1) |

Fine Frequency Control: If the software believes that the centre frequency is not correct it can issue fine frequency control commands. These will adjust the centre frequency up or down by the specified amount The increments below are measured 1/1000^{th} of a Hz.

| VARIABLE NAME | ATTRIBUTES | RANGE |
|---|---|---|
| Rx_adjust_frequency | N, RW, I | −32768-32767 |
| Tx_adjust_frequency | N, RW, I | −32768-32767 |

Power Control: These messages are indexed so that we can read/set the power of the individual RF output endpoints. The ‘max’ messages find the range of powers available in the RF component. The following ranges are measured in 1/10^{th} of a dBm. Relative power control, and absolute and relative power measurement messages are defined as part of the full OpenIF™ specification, but are not discussed here for simplicity.

| VARIABLE NAME | ATTRIBUTES | RANGE |
|---|---|---|
| Rx_power_max | Y, RO, I | −32768-32767 |
| Rx_power | Y, RO, I | −32768-32767 |
| Tx_power_max | Y, RO, I | −32768-32767 |
| Tx_power | Y, RW, I | −32768-32767 |

RF Status Messages: Again these messages are indexed so that we can read/set the power of the individual tx/rx elements. These messages are designed to inform the GBP of the current status of the hardware. The ‘max’ messages determine the permissible range of each variable monitored.

| VARIABLE NAME | ATTRIBUTES | RANGE |
|---|---|---|
| Rx_agc_value | Y, RO, I | 0-65535 |
| PA_Voltage | Y, RO, I | −32768-32767 (1/10^{th} V) |
| PA_Voltage_max | Y, RO, I | −32768-32767 (1/10^{th} V) |
| PA_Current | Y, RO, I | −32768-32767 (1/10^{th} A) |
| PA_Current_max | Y, RO, I | −32768-32767 (1/10^{th} A) |
| Tx_temperature | Y, RO, I | −32768-32767 (° C. × 100) |
| Tx_temperature_max | Y, RO, I | −32768-32767 (° C. × 100) |
| Rx/Tx frequency stability | Y, RO, I | −32768-32767 (1/100^{th} ppm) |
| Rx/Tx stability_max | Y, RO, I | −32768-32767 (1/100^{th} ppm) |

Frame/Slot Configuration: The following messages are indexed so that we can enable and disable the power on a per slot basis.

| VARIABLE NAME | ATTRIBUTES | RANGE |
|---|---|---|
| Ssdt_frame | Y, WO, I | Frame number on which to |
| | | apply the ssdt value |
| Ssdt_value | Y, RW, I | 1 = turn power on |
| | | 0 = turn power off |

Trap Messages: The following error conditions will generate trap messages from the RF hardware to the GBP.

| VARIABLE NAME | ATTRIBUTES | ERROR |
|---|---|---|
| Tx_power | Y, RW, I | > Tx_power_max |
| Rx_power | Y, RO, I | > Rx_power_max |
| Rx/Tx frequency stability | Y, RO, I | \|>\| Stability_max |
| Tx_temperature | Y, RO, I | > Tx_temperature_max |
| PA_Voltage | Y, RO, I | > PA_Voltage_max |
| PA_Current | Y, RO, I | > PA_Current_max |

Additionally the font end hardware shall generate a trap message if a CP timeout condition is reached, whereby the hardware has received no control messages for a set period of time.

Simple Example

An example of a specific UMTS message sequence for a single slot transmission might be:
configure the number of samples per slot (Tx_samples_per_slot),
configure the number of bits per sample (Tx_bits_per_sample),
configure the number of dac bits (Tx_dac_bits),
configure the transmitter power (Tx_power),
configure the transmitter center frequency (Tx_centre_frequency_exponent, Tx_centre_frequency_value)
and finally, enable the power for the appropriate slot if has not already been enabled (ssdt_frame,ssdt_value).
   Application Specific Messages

These are commands specific to a specific implementation, although it may be possible to make some of them generic. These will be defined as a separate SNMP MIB.

The RF module's vendor may also wish to support additional vendor specific commands. These are defined in a separate vendor supplied SNMP MIB.

The OpenIF™ protocol also allows for introspection and announcement using the standard SNMP mechanisms; this allows e.g. a GBP to find out dynamically what RF components it has attached and what their capabilities are, prior to any communication.

OpenIF™ Summary

OpenIF™ is an open RF/digital domain interface that makes extensive use of existing protocol technology (UDP/IP and SNMP).
The control and management of the connected RF hardware is performed through a standard set of messages, which can be reused when developing wireless products for alternative telecommunication standards.
OpenIF™ allows the integration of 3^{rd} party RF hardware and even the development of standardised test equipment for approval testing of software stacks.
OpenIF™ allows the manufacturer to migrate the developed software solution to an ASIC without complete knowledge of the RF hardware to be deployed.
OpenIF™ allows the manufacturer to focus resources on the development of alternative telecommunication standards instead of re-inventing RF configuration and management systems.
OpenIF™ allows RF vendors to concentrate on providing a good analogue product, without the burden of providing the increasingly complex digital component, and similarly frees the provider of the digital processing system from the vagaries of analogue hardware. This should increase the number of players able to participate in the market, thereby increasing competition and so reducing price while increasing product availability and quality.
OpenIF™ promotes reuse of hardware on both the digital and analogue sides across multiple systems and, where appropriate, multiple standards.

OpenIF™ supports antenna arrays and antenna diversity through the use of IP endpoint addressing.

Bibliography

| REF. | TITLE | AUTHOR/SOURCE |
|---|---|---|
| RFC 791 | Official specification of IP | Postel 1981a |
| RFC 768 | UDP Header | Postel 1980 |
| RFC 1157 | The structure of the SNMP header. | Case et al. 1990 |
| RFC 1213 | SNMP MIBs | McCloghrie and |
| | | Rose 1991 |
| Physical Radio | http://www.sdrforum.org/docs/ | Dave Beyer |
| Interface | mmits-docs/glomo_phyr_int.pdf | (Rooftop Comms) |
| Specification | | 1998 |

1-16. (Cancelled)

17. A method of sending and receiving digital data between an analogue RF hardware and digital processing hardware, comprising the step of:
sending and receiving the data using an open communications protocol such that no custom driver is needed at either the analogue RF hardware or digital processing hardware to control the sending and receiving of data.

18. The method of claim 17 in which the protocol is UDP/IP.

19. The method of claim 17 in which messages are formed using separate packets for content related data, control data and management data.

20. The method of claim 19 in which a packet for content related data uses a header which defines data packing as either sequential IQ signals or a real IF stream.

21. The method of claim 19 in which control and management data packets are re-useable across several different communications standards and use a communications protocol which is independent of any one communications standard.

22. The method of claim 21 in which the messaging protocol is SNMP.

23. The method of claim 17 in which message types are used, said message types selected from the group consisting of:
(a) reception and transmission of content related data;
(b) control and management messages from the digital processing hardware to the analogue RF hardware;
(c) responses from the analogue RF hardware to queries from the digital processing hardware; and
(d) traps generated by the analogue RF hardware.

24. The method of claim 17 which is extensible.

25. The method of claim 17 in which time stamp data is generated to allow use of synchronous as well as asynchronous transports.

26. The method of claim 17 in which the steps of introspection and announcement occur in order to enable dynamic discovery of the capabilities of the analogue RF hardware.

27. The method of claim 17 in which IP endpoint addressing is used to enable antenna arrays to be addressed.

28. The method of claim 17 in which the digital processing hardware supports software defined radio.

29. Analogue RF hardware adapted to send digital data to, and to receive digital data from, digital processing hardware, in which the analogue RF hardware uses an open communications protocol such that no custom driver is needed at the analogue RF hardware to control the sending and receiving of data.

30. Digital processing hardware adapted to send digital data to, and to receive digital data from, analogue RF hardware, in which the digital processing hardware uses an open communications protocol such that no custom driver is needed at the digital processing hardware to control the sending and receiving of data.

31. An apparatus for sending and receiving digital data between an analogue RF hardware and digital processing hardware:
means for sending and means for receiving the data using an open communications protocol such that no custom driver is needed at either the analogue RF hardware or digital processing hardware to control the sending and receiving of data.

32. The apparatus of claim 31 further comprising means for forming messages using separate packets for content related data, control data and management data.

33. The apparatus of claim 31 further comprising means for generating time stamp data to thereby allow use of synchronous as well as asynchronous transports.

34. The apparatus of claim 31 further comprising means for utilizing IP endpoint addressing to thereby enable antenna arrays to be addressed.
